(19) United States
(12) Patent Application Publication
(10) Pub. No.: US 2015/0003280 A1
(43) Pub. Date: Jan. 1, 2015

(54) REPORTING CONGESTION IN ACCESS NETWORKS TO THE CORE NETWORK

(71) Applicant: CYGNUS BROADBAND, INC., SAN DIEGO, CA (US)

(72) Inventors: Erik Colban, San Diego, CA (US); David Gell, San Diego, CA (US); Kenneth L. Stanwood, Vista, CA (US)

(21) Appl. No.: 14/315,896

(22) Filed: Jun. 26, 2014

Related U.S. Application Data
(60) Provisional application No. 61/839,475, filed on Jun. 26, 2013.

(51) Int. Cl. H04L 12/26; H04L 12/801

(52) U.S. Cl. CPC H04L 43/062; H04L 43/0888; H04L 47/11
USPC 370/253

(57) ABSTRACT

A network node in a core network is provided information about congestion in an access network coupled to the core network. The information about congestion includes a congestion identifier associated with a bearer that can be sent from an access node in the access network to a network node in the core network. The congestion identifier is associated with a set of bearers. The information about congestion also includes a congestion level indication sent from the access node to the network node. The network node maintains associations between the congestion identifiers and the bearers and can mitigate congestion on one or more bearers in the set of bearers associated with a congestion identifier in response to the congestion level indication.

### CROSS-REFERENCE TO RELATED APPLICATIONS

The application claims the benefit of U.S. provisional patent application Ser. No. 61/839,475, entitled “Reporting Congestion in the RAN to the Core Network,” filed Jun. 26, 2013, which is hereby incorporated by reference.

### BACKGROUND

The present invention relates to communication systems and, more particularly, to reporting congestion in access networks to the core network.

In the field of wireless communication systems, the Third Generation Partnership Project (3GPP) is currently working on amendments to the specifications to address user plane congestion. This work is being conducted under the work item “User Plane Congestion management (UPCON).” 3GPP has produced a feasibility study document (3GPP TR 22.805 v2.0.0 (2012-08): “Feasibility study on user plane congestion management”), added requirements for UPCON in 3GPP TS 22.101 v12.4.0 (2013-03): “Service principles” (Clause 27), and produced a technical report (“the TR”) 3GPP TR 23.705 v0.5.0 (2013-06): “System Enhancements for User Plane Congestion Management.” Other documents produced by 3GPP related to or that may aid in understanding UPCON include: 3GPP TS 23.060 v12.0.0 (2013-03): “General Packet Radio Service (GPRS); Service description; Stage 2”; 3GPP TS 23.401 v12.0.0 (2013-03): “General Packet Radio Service (GPRS) enhancements for Evolved Universal Terrestrial Radio Access Network (E-UTRAN) access”; 3GPP TS 23.402 v12.0.0 (2013-03): “Architecture enhancements for non-3GPP accesses”; and 3GPP TS 21.905 v11.3.0 (2012-12): “Vocabulary for 3GPP Specifications.”

The TR defines radio access network (RAN) user plane congestion as: “RAN user plane congestion occurs when the demand for RAN resources exceeds the available RAN capacity to deliver the user data for a period of time. RAN user plane congestion leads, for example, to packet drops or delays, and may or may not result in degraded end-user experience.”

The TR identifies two approaches to handling RAN user plane congestion. The first approach is RAN-based congestion handling, and the second approach is core network (CN) based congestion handling.

In RAN-based congestion handling, the evolved Node B (eNB or eNodeB) enforces mitigation, for example, by dropping or delaying packets. The eNB may determine which bearers to enforce such measures on through quality of service (QoS) attributes associated with the bearers and possible additional indications from the CN. Indications from the CN may be in the form of packet markings, whereby the CN adds an index or indicator to each downlink packet sent on each bearer, and the eNB uses these markings to determine how to handle the marked packets. The markings could indicate a priority or more detailed QoS handling. Unless packet marking is to be turned on and off depending on whether there is congestion in the RAN, RAN-based congestion handling does not require the CN to be aware of the congestion in the RAN. However, if the packet marking is to be turned on and off depending on the congestion of the RAN or, more generally, dependent of the congestion level in the RAN, the eNBs need to signal to the CN when there is an onset or abatement of congestion and the CN needs to determine the bearers that require packet marking.

In CN-based congestion handling, the RAN signals the onset and abatement of congestion (or more generally, the level of congestion) and the CN determines and enforces mitigation measures. The mitigation measures may take place in the CN, the RAN, or both. One key problem with CN based solutions is how to identify the traffic flows that are served by a congested cell, so that the CN can identify to which flows mitigation measures need to be applied. According to current 3GPP specifications, the mapping of traffic flows to cells may not be available at the entity (or entities) that may determine or enforce mitigation measures (e.g. PGW). Proposals submitted to 3GPP either do not address this problem or suggest that the RAN identify not only the cell where there is congestion, but also the bearers that are impacted by or contribute to the congestion. This may impair network performance due to high signaling volume and high processing load at the entities in the CN that have to process this signaling.

### SUMMARY

In one aspect, a method is provided for an access node to report access network congestion to a network node in a core network. The method includes: detecting a bearer transition event for a first bearer associated with a user equipment that is in communication with the access node; determining a congestion identifier that is associated with a set of bearers for association with the first bearer; and sending the congestion identifier and information identifying the first bearer to the network node.

In one aspect, an access node serving a cell in an access network coupled to a core network is provided that includes: a transceiver module configured to receive and send data via the access network; a backhaul interface module configured to receive and send data via the core network; a memory module; and a processor module coupled to the transceiver module, the backhaul interface module, and the memory module and configured to: detect a bearer transition event for a first bearer associated with a user equipment that is in communication with the access node; determine a congestion identifier that is associated with a set of bearers for association with the first bearer and send the congestion identifier and information identifying the first bearer from the access node to a network node.

In one aspect, a method is provided for a network node in a core network to manage congestion in an access network coupled to the core network. The method includes: receiving a congestion identifier and information identifying a first bearer; associating the congestion identifier with the first bearer based on the information identifying the first bearer; receiving a congestion level indication; and associating the congestion level indication with the congestion identifier.

In one aspect, a network node in a core network coupled to an access network is provided that includes: an input/output module configured to communicate with an access node in the access network; a memory module; and a processor module coupled to the input/output module and the memory module and configured to: receive, from the access node, a congestion identifier and information identifying a first bearer; associate the congestion identifier with the first bearer based on the information identifying the first bearer; receive, from the access node, a congestion level indication; and associate the congestion level indication with the congestion identifier.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a block diagram of a communication network in which systems and methods disclosed herein can be implemented in accordance with aspects of the invention;

FIG. 2 is a functional block diagram of a network node in accordance with aspects of the invention;

FIG. 3 is a functional block diagram of an access node in accordance with aspects of the invention;

FIG. 4 is a functional block of a terminal node in accordance with aspects of the invention;

FIG. 5 is a flowchart of a process for an access node to support the reporting of access network congestion to a network node in a core network in accordance with aspects of the invention;

FIG. 6 is a flowchart of a process for a network node in a core network to support the management of congestion in an access network coupled to the core network in accordance with aspects of the invention;

FIG. 7 is a flowchart of a process for an access node to report access network congestion to a network node in a core network in accordance with aspects of the invention; and

FIG. 8 is a flowchart of a process for a network node in a core network to manage congestion in an access network coupled to the core network in accordance with aspects of the invention.

### DETAILED DESCRIPTION

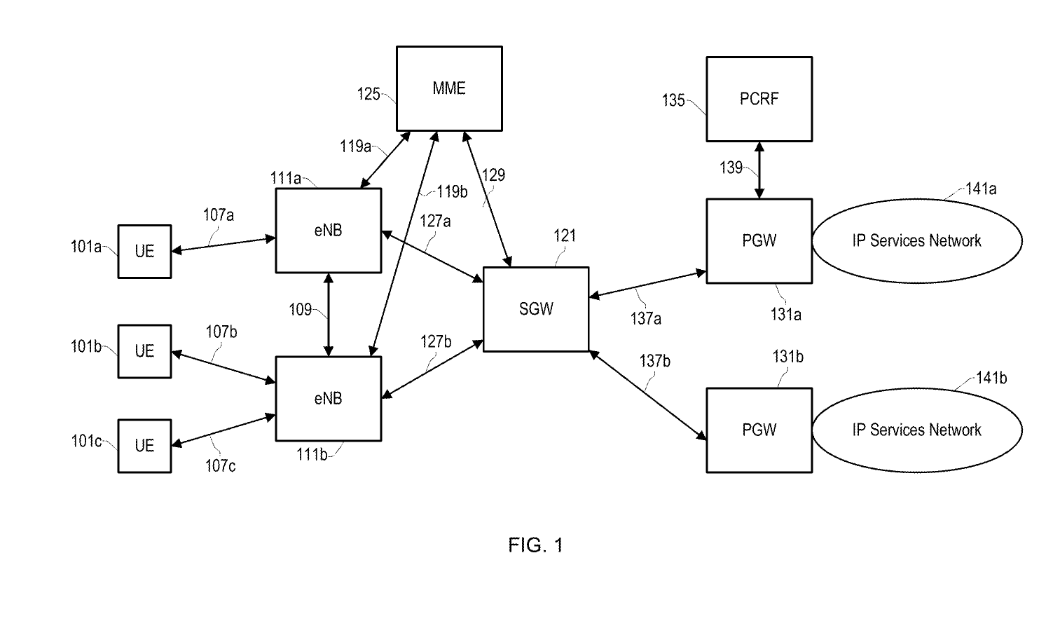

FIG. 1 is a block diagram of a communication network in which systems and methods disclosed herein can be implemented in accordance with aspects of the invention. The communication network of FIG. 1 is an example deployment of a 3GPP network. The communication network of FIG. 1 is simplified to focus on aspects related to reporting congestion in radio access networks to the core network. For example, a communication network will commonly include many more instances of each of the various types of devices shown in FIG. 1. The disclosed systems and methods can be used in many other communication networks.

The communication network includes three user equipments (UE) 101 (including 101a, 101b, 101c). Each of the user equipments 101, which may also be referred to as a terminal, a handset, a smart phone, a mobile station, etc., is the equipment through which a user communicates with the network.

A UE may be in one of two Evolved Packet System (EPS) Mobility Management (EMM) states: EMM-DEREGISTERED and EMM-REGISTERED. In the EMM-DEREGISTERED state, the UE's location is not known by the network. The UE may enter the EMM-REGISTERED state through an attach procedure. Once in the EMM-REGISTERED state, a UE may be in one of two EPS Connection Management (ECM) states: ECM-IDLE and ECM-CONNECTED. A UE in the ECM-IDLE state has no Non-Access Stratum (NAS) signaling connection to the network, which briefly described, means that the UE cannot partake in any upper layer signaling and the exchange of user data cannot take place. A UE in the ECM-REGISTERED state and the ECM-IDLE state informs the network about its location by initiating Tracking Area updates and may be paged.

The communication network includes two eNBs 111 (including 111a, 111b). The eNBs 111, also known as access nodes, base stations, or base transceiver stations, are responsible for transmission and reception in one or more cells. The eNBs 111 and the UEs 101 communicate wirelessly in the cells over air interfaces 107 (including 107a, 107b, 107c). The 3GPP specifications reference the air interfaces 107 between the UEs 101 and the eNBs 111 as the Uu interface. When a UE is in the ECM-IDLE state, the eNB need not maintain any state for the UE. The eNBs 111 may also communicate with each other via connection 109, which may be a wireless or a wireline connection. The eNBs 111 operate in the radio access network portion of the communication network.

A Mobility Management Entity (MME) 125 manages and stores UE context, such as the mobility state, and is also involved in authentication and authorization. A communication link 119a between the eNB 111a and the MME 125 and a communication link 119b between the eNB 111b and the MME 125 are specified by the S1-MME reference point in LTE.

A Serving Gateway (SGW) 121 routes packets between the eNB 111 and a Packet Data Network (PDN) Gateways (PGW) 131 (including 131a, 131b). The SGW 121 serves as a mobility anchor, which means that a UE may move from one eNB 111 to another while the SGW 121 stays the same and with no need to update the data path between the SGW 121 and the PGW 131.

The PGW 131 provides access to Internet protocol (IP) services networks 141 (including 141a, 141b). The (IP) services networks 141 provide access to IP-based services, for example, services provided by a wireless network operator or services accessible through the Internet. The UE 101 may have simultaneous connectivity to more than one PGW 131. The PGW 131 performs policy enforcement and charging support based on rules provided by a Policy and Charging Rules Function (PCRF) 135. The PGW 131 communicates with the PCRF 135 over a communication interface 139, for example, using the Gx reference point specified by 3GPP. The SGW 121, MME 125, PGWs 131, and PCRF 135 operate in the core network portion of the communication network.

When a UE enters the ECM-CONNECTED state, hands over from one eNB (the source eNB) to another eNB (the target eNB), or a new EPS bearer is established between the UE and the PGW, a bearer tunnel (referred to as a General Packet Radio Service (GPRS) Tunneling Protocol user plane (GTP-U) tunnel) is established between the SGW and the target eNB for each EPS bearer that exists between the UE and the PGW. The bearer tunnel allows user data packets to flow between the eNB and the SGW. The SGW communicates with the MME using protocols over a communication link 129, for example, as specified for an S11 reference point. The GTP-U tunnels between the eNB and the SGW are established over communication links 127 (including 127a, 127b), for example, using the S1-U interface specified by 3GPP. The GTP-U tunnels between the eNBs 111 and the SGW 121 may be referred to as S1-U tunnels.

The 3GPP specifications allow EPS bearers to be GTP based or Proxy Mobile IP (PMIP) based. When the EPS bearers are GTP based, a GTP-U tunnel is also established between the SGW 121 and the PGW 131. The interface between the SGW 121 and the PGW 131 use communication links 137 (including 137a, 137b), for example, using the S5 interface specified by 3GPP (when SGW and PGW are in the same home network and S8 specified by 3GPP (when the SGW is in a visited network and the PGW is in the home network) reference points. Unlike the GTP-U tunnels between the eNB 111 and the SGW 121, the tunnels between the SGW 121 and the PGW 131 are not released when the UE enters the ECM-IDLE state or moves to another eNB. Normally, these events do not involve any signaling to or from the PGW.

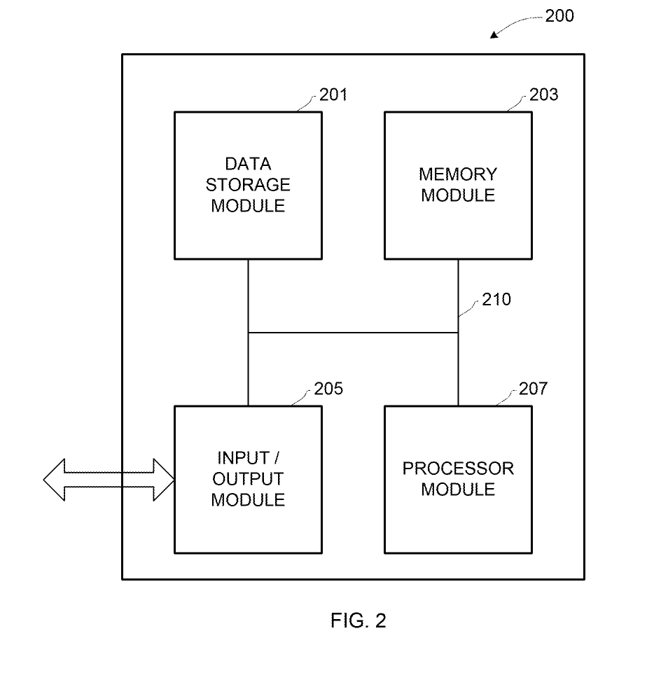

FIG. 2 is a functional block diagram of a network node 200 in accordance with aspects of the invention. In various embodiments, the network node 200 may be a SGW, a mobility management entity (MME) node, a PDN gateway, a policy and charging rules function (PCRF) node, or some other node. The network node 200 may be used, for example, to implement the SGW 121, MME 125, PGWs 131, or PCRF 135 of the communication network of FIG. 1.

The network node 200 includes a bus 210 or other communication mechanism for communicating information and a processor module 207 coupled with the bus 210 for processing information. The network node 200 also includes a memory module 203, such as a random access memory (RAM) or other dynamic storage device, coupled to the bus 210 for storing information and instructions to be executed by processor module 207. The memory module 203 may also be used for storing temporary variables or other intermediate information during execution of instructions by the processor module 207. The network node 200 may further include a data storage module 201, such as a magnetic disk, optical disk, or solid state memory device, coupled to the bus 210 for storing information and instructions.

The network node 200 may be coupled via an input/output module 205 to a display device (not illustrated), such as a cathode ray tube (CRT) or liquid crystal display (LCD) for displaying information to a user of the network node 200. An input device, such as, for example, a keyboard or a mouse may also be coupled to the network node 200 via the input/output module 205 for communicating information and command selections to the processor module 207. The input/output module 205 may also be couple to a network such as a local-area network (LAN), wide-area network (WAN), internet, or other network, whether a wireline network or a wireless network. In this regard, the input/output module 205 may comprise, or be connected to, one or more network connection devices and/or transceivers for establishing one or more network connections, either to wireline or wireless networks.

Various functions and methods described herein may be performed by the network node 200 by the processor module 207 executing one or more sequences of instructions contained in the memory module 203. Network node 200 may perform the functions and methods described herein to implement congestion mitigation. Such instructions may be read into the memory module 203 from another machine-readable medium, such as the data storage module 201. One or more processors in a multiprocessing arrangement may also be employed to execute sequences of instructions contained in the memory module 203 or received from another source via the bus 210. In alternative embodiments, hard-wired circuitry may be used in place of or in combination with software instructions to implement the various functions and methods. In an embodiment, the data storage module 201, the memory module 203, or parts thereof may be considered a non-transitory machine readable medium.

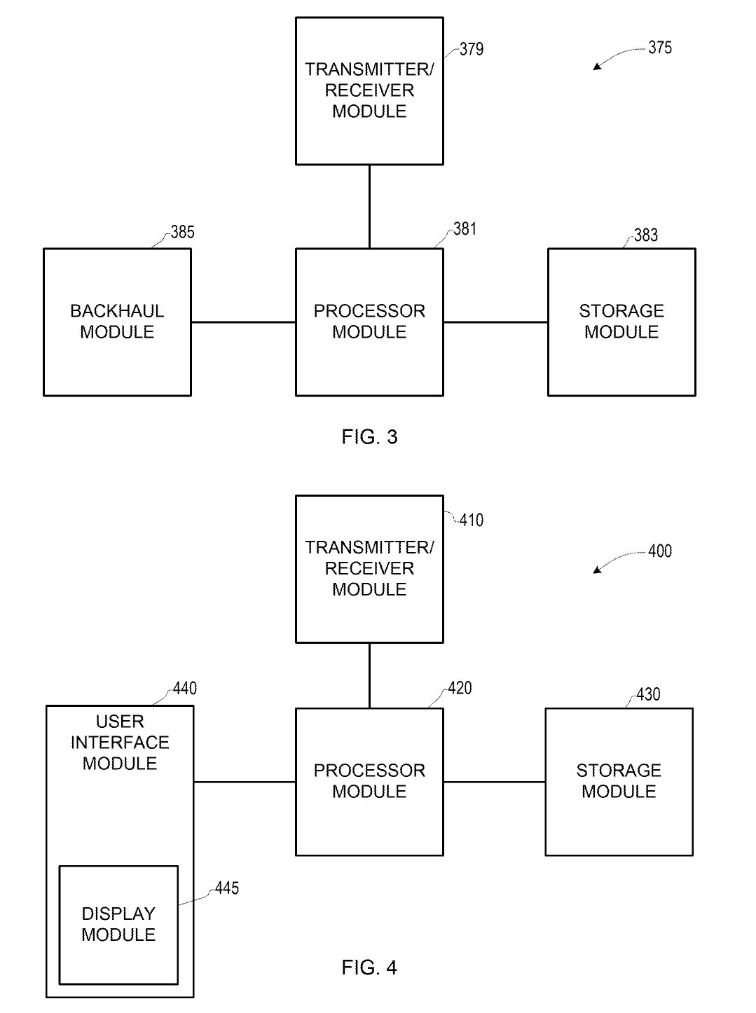

FIG. 3 is a functional block diagram of an access node 375 in accordance with aspects of the invention. In various embodiments, the access node 375 may be a mobile WiMAX base station, a global system for mobile (GSM) wireless base transceiver station (BTS), a Universal Mobile Telecommunications System (UMTS) NodeB, an LTE evolved Node B (eNB or eNodeB), a cable modem headend, or other wireline or wireless access node of various form factors. Such form factors may be, for example, a macro base station, a pico station, or an enterprise femtocell. The access node 375 may be used, for example, to implement the eNBs 111 of the communication network of FIG. 1. The access node 375 includes a processor module 381. The processor module 381 is coupled to a transmitter-receiver (transceiver) module 379, a backhaul interface module 385, and a storage module 383.

The transmitter-receiver module 379 is configured to transmit and receive communications with other devices. In many implementations, the communications are transmitted and received wirelessly. Accordingly, the access node 375 may include one or more antennae for transmission and reception of radio signals. In other aspects, the communications may be transmitted and/or received over physical connections such as wires or optical cables. The communications of the transmitter-receiver module 379 may be with terminal nodes. Functions of the processor module 381, the transmitter-receiver module 379, and the associated antennas may be co-located or geographically separated, such as in C-RAN (centralized or cloud RAN) or DAS (distributed antenna system) deployments.

The backhaul interface module 385 provides communication between the access node 375 and a core network. The communication may be over a backhaul connection. Communications received via the transmitter-receiver module 379 may be transmitted, after processing, on the backhaul connection. Similarly, communication received from the backhaul connection may be transmitted, after processing, by the transmitter-receiver module 379. Although the access node 375 of FIG. 3 is shown with a single backhaul interface module 385, other embodiments of the access node 375 may include multiple backhaul interface modules. Similarly, the access node 375 may include multiple transmitter-receiver modules. The multiple backhaul interface modules and transmitter-receiver modules may operate according to different protocols.

The processor module 381 can process communications being received and transmitted by the access node 375. The storage module 383 (which may also be referred to as memory, memory device, memory module, or similar terms) stores data for use by the processor module 381. The storage module 383 may also be used to store computer readable instructions for execution by the processor module 381. The computer readable instructions can be used by the access node 375 for accomplishing the various functions of the access node 375. In an embodiment, the storage module 383 or parts of the storage module 383 may be considered a non-transitory machine readable medium. For concise explanation, the access node 375 or aspects of it are described as having certain functionality. It will be appreciated that in some implementations, this functionality is accomplished by the processor module 381 in conjunction with the storage module 383, transmitter-receiver module 379, and backhaul interface module 385. Furthermore, in addition to executing instructions, the processor module 381 may include specific purpose hardware to accomplish some functions.

FIG. 4 is a functional block diagram of a terminal node 400 in accordance with aspects of the invention. In various embodiments, the terminal node 400 may be a smartphone, a laptop, a tablet device, a computer, or the like. The terminal node 400 may be used, for example, to implement the UEs 101 of the communication network of FIG. 1. The terminal node 400 includes a processor module 420. The processor module 420 is coupled to a transmitter-receiver (transceiver) module 410, a user interface module 440, and a storage module 430.

The transmitter-receiver module 410 is configured to transmit and receive communications with other devices. For example, the transmitter-receiver module 410 may communicate with a cellular or broadband base station such as an LTE evolved node B (eNodeB) or WiFi access point. In embodiments where the communications are wireless, the terminal node 400 generally includes one or more antennae for transmission and reception of radio signals. In other embodiments, the communications may be transmitted and/or received over physical connections such as wires or optical cables and the transmitter-receiver module 410 may be an Ethernet adapter or cable modem. Although the terminal node 400 of FIG. 4 is shown with a single transmitter-receiver module 410, other embodiments of the terminal node 400 may include multiple transmitter-receiver modules. The multiple transmitter-receiver modules may operate according to different protocols.

The terminal node 400, in some embodiments, provides data to and receives data from a person (user). Accordingly, the terminal node 400 may include a user interface module 440. The user interface module 440 includes modules for communicating with a person. The user interface module 440, in an exemplary embodiment, includes a display module 445 for providing visual information to the user, including displaying video content. In some embodiments, the display module 445 includes a touch screen which may be used in place of or in combination with a keypad. The touch screen may allow graphical selection of inputs in addition to alphanumeric inputs.

In an alternative embodiment, the user interface module 440 includes a computer interface, for example, a universal serial bus (USB) interface, to interface the terminal node 400 to a computer. For example, the terminal node 400 may be in the form of a dongle that can be connected, by a wired connection or a wireless connection, to a notebook computer via the user interface module 440. The combination of computer and dongle may also be considered a terminal node. The user interface module 440 may have other configurations and include functions such as vibrators and lights.

The processor module 420 can process communications received and transmitted by the terminal node 400. The processor module 420 can also process inputs from and outputs to the user interface module 440. The storage module 430 may store data for use by the processor module 420, including images or metrics derived from images. The storage module 430 may also be used to store computer readable instructions for execution by the processor module 420. The computer readable instructions can be used by the terminal node 400 for accomplishing the various functions of the terminal node 400. Storage module 430 can also store received content, such as video content that is received via the transmitter-receiver module 410.

The storage module 430 may also be used to store photos and videos, or portions thereof. In an embodiment, the storage module 430 or parts of the storage module 430 may be considered a non-transitory machine readable medium. In an embodiment, storage module 430 may include a subscriber identity module (SIM) or machine identity module (MIM).

For concise explanation, the terminal node 400 and various embodiments of it are described as having certain functionality. It will be appreciated that in some embodiments, this functionality is accomplished by the processor module 420 in conjunction with the storage module 430, the transmitter-receiver module 410, and the user interface module 440. Furthermore, in addition to executing instructions, the processor module 420 may include specific purpose hardware to accomplish some functions.

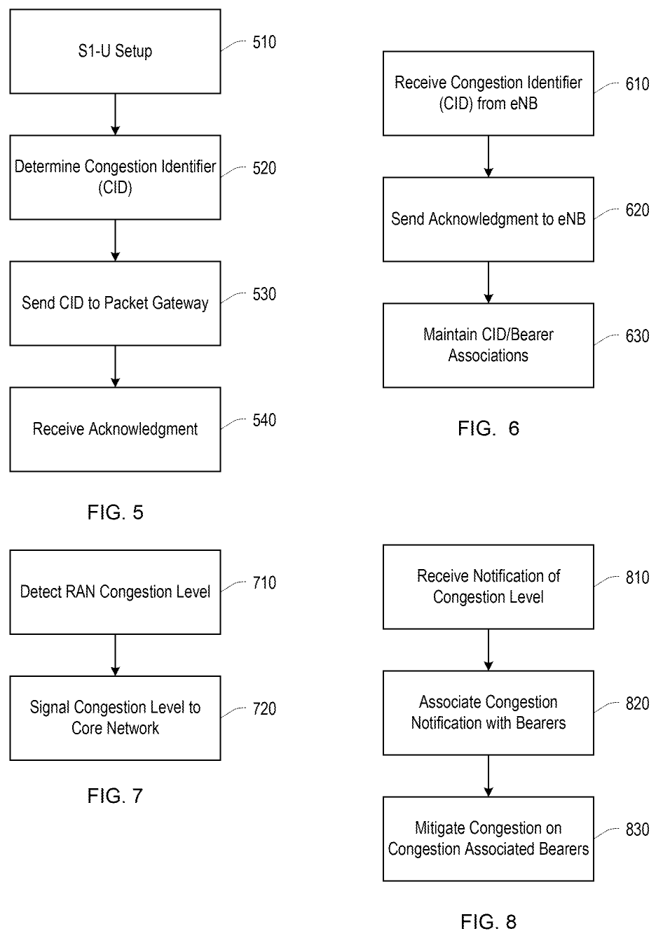

FIGS. 5, 6, 7, and 8 are flowcharts of processes for use in reporting access network congestion to a core network. To provide specific examples, the processes will be described with reference to the communication network of FIG. 1 but are not so limited.

The processes include a congestion identifier part and a congestion status part. To allow the CN to identify the bearers served by a congested access network, a two-part approach is used. There can be a loose time dependency between the two parts. The CN uses information from both parts to take appropriate congestion mitigation measures. However, there is no requirement that one part be completed before the other and the congestion identifier part and the congestion status part may be concurrent.

For example, the congestion identifier part may take place after a bearer tunnel is set up between the eNB 111 and the SGW 121 or when a bearer is setup between eNB 111 and UE 101. The bearer tunnel setup can be referred to as S1-U setup. The congestion identifier part informs the CN about bearers that may be impacted by congestion in the access network or may be contributing to congestion in the access network. In an aspect, the congestion identifier part may be performed one or more times for each bearer.

The congestion status part can take place when there is a change in congestion level in the access network. The congestion status part informs the CN about congestion or a change in congestion level.

FIG. 5 is a flowchart of a process for an access node to support the reporting of access network congestion to a network node in a core network in accordance with aspects of the invention. In this example, the network node may be a PGW or another node that supports congestion reporting functionality. The process may be performed, for example, by the eNB 111 in the communication network of FIG. 1.

In step 510, the access node detects a bearer transition event associated with a UE which may be a bearer setup or a bearer handover. In an aspect, a bearer transition event may be associated with one of the following: (1) the UE attaches to the network; (2) the UE hands over to the access node from another access node; (3) the UE transitions from the idle state (e.g., ECM-IDLE in LTE) to the connected state (e.g., ECM-CONNECTED in LTE); or (4) a new bearer associated with the UE is established. The establishment of a new bearer may, for example, be a setup of a bearer tunnel between the access node and a serving gateway, a setup of a bearer between the access node and the UE, or a setup of a bearer between the UE and a network node. In an aspect, in an LTE system, a bearer tunnel may be an S1-U tunnel. In an aspect, in an LTE system, a bearer may be an EPS bearer or a radio access bearer.

In step 520, the access node determines a congestion identifier (CID). The congestion identifier (CID) is used to identify a set of bearers being served by one or more access nodes over which congestion in the access network may be detected and mitigated. The set of bearers may include, for example, all bearers associated with an access network cell, all bearers associated with multiple access network cells, all bearers associated with an access network cell sector, or all bearers of a particular class or classes of service for UEs being served by one or more access network cells. The access node may directly determine the CID or the access node may receive the CID from another network node, for example, the MME or the SGW.

The CID may be determined based on various criteria. Example choices for a CID include Cell ID, Cell Global ID, access node IP address, access node MAC address, Physical Cell ID (PCI), or a random number. The CID can be dynamic, for example, the value of the CID may change periodically or based on events.

If a Cell ID is used as for the CID and the PGW is in a different network than the access node (as is the case for home routed PDN connections for roaming subscribers), the Cell ID may not uniquely identify the cell because the Cell ID allocation in different networks may collide. So, using a Cell ID as the CID may have some limitations; and therefore, some wireless system operators may configure the SGW to intercept the CID so it is not sent to a PGW in another network.

To allow the CID to uniquely identify a cell when sent across networks, the process can use the Cell Global ID (CGI), which is unique across all networks. However, some operators may be reluctant to share information about congestion with roaming partners. In an embodiment, conversion of a Cell ID or Global Cell ID based CID to a random number based CID may be performed (e.g., by the SGW) for those bearers connecting to a PGW of another operator as in a roaming situation.

When the CID is based on a random number, it should be selected from a space large enough so that the probability of a collision with a CID for another cell is sufficiently small (e.g., negligible for practical purposes). Given realistic and very conservative assumptions, an 8-byte number space may be sufficient. Other sized number spaces may be used instead.

The CID may also be based on a combination of criteria. For example, a Cell ID may be used only for EPS bearers that terminate at a PGW in the same network as the SGW, and a CID based on the CGI or on a random number may be used for bearers that terminate at a PGW in a different network. Additionally, the CID may be based on a combination of one or more identifiers and random numbers. For example, the CID may be the concatenation of the Cell ID (or a hash thereof) and a random number.

When using a CID based on a random number, the cell where congestion arises can be hidden to the CN. This is particularly desirable when the PDN is in a different network than the access network. In order to obfuscate the identity of congested cells, the CID may be configured with a “time to live” (TTL). For example, if the TTL is set to 24 hours, the access node may update the CID every 24 hours and send the new CID to the PGW. Additionally, the PGW may be configured to purge EPS bearer-to-CID associations on expiration of the TTL. This has the additional effect of purging stale EPS bearer-to-CID associations.

A CID that may be used to identify EPS bearers affected by a change in congestion level that the access network reports to the CN may be referred to as a live CID. A CID whose TTL has expired is dead, i.e., not live, and is not further used for reporting congestion. In an aspect, an access node may stop the use of a CID prior to the expiration of the TTL.

The access network congestion reporting method may use a null congestion identifier (Null-CID). A Null-CID is a special CID value (e.g., all zeros). A Null-CID may serve as a default CID value for a non-congested cell and may be used to signal to the PGW to remove the EPS bearer-to-CID association of a given EPS bearer. In an aspect, a Null-CID may indicate additional information, such as a cause. For example, certain predetermined bits of a Null-CID may be used to encode such additional information. For example, when a UE hands over from a congested cell to a non-congested cell, the target cell may send a Null-CID to the PGW. This may be used to signal to the PGW that the UE's bearers are no longer served by a congested cell and the PGW may halt congestion mitigation measures for those bearers. This may happen, for example, when a bearer is handed over to a non-congested cell or the UE enters ECM-IDLE state. A Null-CID is not a live CID. The access node may maintain state about which CIDs have been sent to the PGWs for each bearer to avoid duplicated transmissions of the same CID, including, in particular, duplicate transmissions of a Null-CID.

The CID may be allocated autonomously by each eNB, for example, each access node randomly selecting a new value before the TTL expiration. Alternatively, the CID may be configured by the communication network operator. The allocation of CIDs can be performed with or without coordination between operators or a numbering authority for assigning CIDs.

The relationship between CIDs and cells can be other than one-to-one. A common CID may be assigned to an area encompassing multiple cells, for example, if the communication network operator opts to treat congestion uniformly in that area. A common CID may be used for multiple cells covered by the same access node or covered by different access nodes.

Multiple CIDs may be assigned to one cell. For example, one CID may be phased out after introducing a new CID. Additionally, different CIDs can be assigned to different EPS bearer categories with the same cell, for example, to allow reporting of congestion for a subset of the EPS bearers in a cell. For example, EPS bearers associated with a Guaranteed Bite Rate (GBR) may be associated with a different CID than non-GBR bearers, or may not be associated with a CID, and the access node may, for example, report congestion using the CID associated with the non-GBR bearers only.

Returning to FIG. 5, in step 530, the access node sends the CID to the PGW. The access node may send the CID to the PGW in various ways. The access node may send the CID in a packet on the EPS bearer. That is, the access node inserts a packet containing the CID into the S1-U tunnel supporting the EPS bearer. The SGW forwards the packet to the PGW. The packet may be marked such that the PGW can easily identify the packets containing a CID from the other packets that the PGW receives. For example, the packet may contain a GTP-U header that identifies that the packet contains a CID. The CID may be sent as part of a GTP-U header (e.g., in the Extension Header Content field of an Extension Header) or in an Information Element (IE) of a GTP-U signaling message that is used for signaling the CID.

Sending of the CID from the access node to the PGW for every S1-U bearer setup may result in a large signaling overhead and processing overhead at the PGW, since the events that require an update of the EPS bearer-to-CID association (e.g., transitions from ECM-IDLE state to ECM-CONNECTED state, handovers, new EPS bearers are established) may occur frequently. Various methods may be used, singly or in combination, to reduce the overhead.

To reduce this signaling, the access node may send CIDs only after congestion occurs. Alternatively or additionally, the access node may send CIDs only when likely to become congested in the near future based, for example, on a probability that access network congestion will occur within a predetermined time window (e.g., 1 second) exceeding a predetermined threshold. There are multiple ways that the access node may estimate this probability. For example, the access node may base a probability estimate on the resource utilization (e.g., percentage of physical resource blocks used), number of kilobytes in scheduling queues, age of packets in the queues, or any combination of the above. The probability estimate may also be based on learned congestion patterns, for example, congestion may be more likely to occur at certain hours of the day.

Often, congestion has a brief duration (e.g., a few seconds or less). The access node may reduce overhead by not be reporting brief congestion to the CN. In such cases, the access node may deal with the congestion directly. Congestion may need to have duration longer than a threshold in order to be reported to the CN.

The access node may use information about brief congestion events to estimate congestion probability to trigger signaling. For example, the frequency of brief congestion events, their severity, and their duration may be used as an indication of longer lasting congestion in the near future. The congestion reporting can still be effective when the congestion probability estimates are not very precise, since the access node may send the CIDs to the PGWs after congestion has occurred.

The access node may, to reduce signaling, decide when to send (e.g., delayed or not delayed) the CID for a bearer depending on characteristics of the bearer, characteristics of the associated UE, or combinations thereof. Example bearer characteristics include the QoS Class Indicator (QCI) of the bearer, the type of the traffic that is transmitted over the bearer, or the amount of resources allocated to the bearer. Example UE characteristics include the service level agreement (SLA) or other policies associated with the UE (e.g. Gold, Silver, or Bronze service agreements). When the access node sends the CID before the occurrence of congestion, the CN may be able to react more promptly with mitigation measures on bearers that contribute more heavily toward congestion.

There may be situations when a UE hands over from a cell to another cell and the two cells have different congestion levels or the congestion levels become different in the near future. For example, the UE may hand over from a congested cell to a non-congested cell. When handing over, it can improve congestion management when the PGWs are promptly signaled to dissociate the EPS bearers from the CID of the source cell. This can allow the CN to promptly adjust the congestion mitigation measures to accommodate the congestion level in the target cell. This may be achieved by performing one or both of the following two steps.
1) If a CID associated with any of the EPS bearers of a UE that is handed over is currently live, the source access node sends a Null-CID for each of those EPS bearers to the PGWs just prior to the handover, thereby instructing the PGW to dissociate the bearers with the live CID.
2) For each EPS bearer of a UE that is handed over, the target access node may or may not send a live CID to the PGWs. For example, if the target access node is neither congested nor likely to become congested before the UE either hands over to another access node or enters ECM-IDLE state, the target access node may omit sending a live CID to the PGWs. Otherwise, the target access node may send a live CID to the PGWs. The target access node may omit sending a Null-CID to the PGWs, because the target access node may assume that the bearers are not associated with a live CID when they are handed over.

An alternative method for supporting the reporting of access network congestion in handover cases includes the source access node signaling the target access node whether any of the EPS bearers of a UE that is handed over are associated with a live CID at the source access node. For example, the source access node may include an indicator of the CID status for each EPS bearer in the handover signaling between the source access node and the target access node (e.g., via the MME). The target access node can then send CIDs based on the received indicators of the CID statuses. For example, if the target access node is neither congested nor likely to become congested before the UE either hands over to another access node or enters ECM-IDLE state, the target access node can send a Null-CID to the PGWs. Otherwise, the target access node can send a live CID to the PGWs. In an aspect, if the indicator from the source access node indicates that no live CID is associated with a bearer and the target access node is not congested, the target access node need not send any CID to the PGW. Otherwise, the target access node may either send a live CID (if it is congested or likely to become congested in the near future) or a Null CID (if it is not congested and not likely to become congested in the near future).

There may be situations where a UE enters the ECM-IDLE state at one (source) cell and enters the ECM-CONNECTED state at different (target) cell and the congestion level at the source cell is different than the congestion level at the target cell when the UE enters the ECM-CONNECTED state or may become different in the near future. For example, a UE may enter the ECM-IDLE state at a congested cell and enter the ECM-CONNECTED state at a non-congested cell. In such situations, it can improve congestion management when the PGWs are promptly signaled to dissociate the EPS bearers from the CID of the source cell. This can allow the CN to promptly adjust congestion mitigation measures to accommodate the congestion level in the target cell. This may be achieved by performing one or both of the following two steps.
1) If the CIDs associated with any of the UE's EPS bearers are currently live, the source access node (serving the source cell) sends a Null-CID for each of those EPS bearer to the PGWs when the UE enters the ECM-IDLE state, thereby instructing the PGWs to dissociate the bearers with the live CID.
2) When the UE enters the ECM-CONNECTED state at the target access node (serving the target cell), the target access node may send a live CID for each EPS bearer to the PGWs. For example, if the target access node is neither congested nor likely to become congested before the UE either hands over to another access node or enters the ECM-IDLE state, the target access node may omit sending a live CID to the PGWs. Otherwise, the target access node may send a live CID to the PGWs. The target access node need not send a Null-CID to the PGWs, because the target access node may assume that the bearers are not associated with a live CID when they previously entered the ECM-IDLE state.

An alternative method for supporting the reporting of access network congestion in such situations is for the source access node to send an indicator to the MME when the UE enters the ECM-IDLE state to indicate whether any of the EPS bearers are associated with a live CID at the source access node. The MME stores this indicator and forwards the indicator to the target access node when the UE enters the ECM-CONNECTED state. If the target access node receives such an indicator, the target access node may send either a live CID or a Null-CID for each of the UE's EPS bearers to the PGWs. For example, if the target access node is neither congested nor likely to become congested before the UE either hands over to another access node or enters the ECM-IDLE state, the target access node may send a Null-CID to the PGWs. Otherwise, the target access node may send a live CID to the PGWs.

Returning to FIG. 5, in step 540, the access node receives a response from the PGW. The PGW may send the response by various methods, for example, as described below with reference to step 620 of the process of FIG. 6. Implementations of the process may omit the response. The response, however, enables reliable signaling of the CID from the access nodes to the PGW. In an embodiment, when the access node sends a CID to a PGW, the access node starts a timer, and if the access node does not receive a response from the PGW before the timer expires, the access node may resend the CID. Alternatives, such as those known to those skilled in the art, (e.g., the use of sequence numbers and negative acknowledgments) to sending a response message may also be used to implement a reliable signaling of the CIDs.

FIG. 6 is a flowchart of a process for a network node in a core network to support management of congestion in an access network coupled to the core network in accordance with aspects of the invention. The network node may be, for example, the PGW 131 of the communication network of FIG. 1 or may be another node that supports congestion management functionality.

In step 610, upon receiving a packet containing a CID, the PGW may extract the received CID, and may also extract other information used to identify the associated bearer. For example, the PGW may inspect the remainder of the packet (header and other extension headers, information elements, and user IP data datagram).

In step 620, the PGW may send a response back to the access node. This response may be sent in the form of a GTP-U signaling message. The GTP-U protocol specifies reliable delivery of signaling messages. The response may alternatively be sent as an extension header. Implementations of the process may omit sending the response.

The response message sent in step 620 may contain information besides serving as an acknowledgment. For example, the PGW may include an identifier in the response to allow the access node to determine which PGW is serving a particular EPS bearer. The access node may make use of this information, for example, when reporting congestion. The PGW identifiers can be, for example, the PGW IP address or media access control (MAC) address, or any identifier that uniquely identifies the PGW at each access node. The PGW identifiers may be randomly generated, for example, similar using random numbers for CIDs as described above.

In step 630, the PGW maintains associations between CIDs and EPS bearers. The PGW may, for example, update a table in which one column identifies the EPS bearer, for example, through the Tunnel End Point ID (TEID), and another column contains the CID that was last received for the corresponding EPS bearer. In this way, the PGW can maintain an association between the EPS bearers and CIDs.

If the UE enters ECM-IDLE state, the access node may signal the PGW with a Null-CID before removing the S1-U tunnels of the UE. Alternatively, the access node may refrain from signaling the PGW in which case the PGW may keep the association between the UE's EPS bearers and CIDs.

FIG. 7 is a flowchart of a process for an access node to report access network congestion to a network node in a core network in accordance with aspects of the invention. The process may be performed, for example, by the eNB 111 in the communication network of FIG. 1. The process of FIG. 7 can be used to report congestion levels or changes in congestion. The process of FIG. 7 can use information from the process of FIG. 5, however, the processes may also be performed concurrently. In this example, the network node may be a PGW or may be another node that performs congestion mitigation functionality.

In step 710 in the process of FIG. 7, the access node detects congestion levels in the cell or cells served by the access node. There are many methods that the access node may use to assess the congestion level in the access network including methods similar to or the same as the methods described above for estimating the probability of congestion. One method the access node may use to assess congestion is to base the congestion level on the percentage of available resources that have been allocated. If the percentage of an access node's available resources that have been allocated is above a threshold, this may be used as an indicator of congestion. Another method the access node may use to assess congestion is to count the number of packets that the access node drops due to lack of available resource to transmit those packets to the UE. Yet another method the access node may use to assess congestion is to take into account the effects on the users' Quality of Experience (QoE). The effect on QoE can take into account the applications associated with the bearers affected by congestion. For example, if a user is watching video, dropped packets may in some situations barely affect the QoE and, in other situations, cause the video to freeze, which severely affects QoE. Yet another method the access node may use to assess congestion is to set certain QoS targets and base the congestion level on whether these targets are met.

In step 720, the access node signals the congestion level determined in step 710 by sending a congestion level indication to the network node. Upon the onset, abatement, or any reportable change in congestion level in the access network, the access node signals the change in congestion level to the CN. The congestion level indication may, for example, a single bit (signaling a binary congestion/no-congestion situation) or several bits representing an integer that maps to one of a set of predefined congestion levels. In an example embodiment, the access node may signal four levels of congestion (e.g., no congestion, mild congestion, medium congestion, or high congestion) to the CN. These levels of congestion may be associated with configurable target thresholds such as number of dropped packets, bitrates, or other criteria.

There are several methods that the access node may use to signal the congestion level to the CN. In each method, the access node uses a CID to identify the EPS bearers that are impacted by the congestion. Since the PGW maintains an association between the EPS bearers and the CID, the PGW can identify the bearers that are affected by or contribute to the congestion.

A method the access node may use to signal congestion in the access network to the CN is in-band congestion signaling. The access node can indicate the congestion level in a GTP-U header. Since there is an association between bearers and CIDs (e.g., as described for the processes of FIGS. 5 and 6), the access node may omit the CID from the in-band congestion signaling.

Rather than signal congestion in every uplink packet on every bearer, in this method, the access node selects one or a subset of bearers for each PGW to which the access node is connected and sends the congestion indication in one or more packets on each of these bearers. The access nodes may maintain an association between the bearers and PGW identifiers. The access node may identify the PGWs as described with reference to step 620 of the process of FIG. 6.

In some cases, the access node may reach step 720 before completing the process of FIG. 5. In such cases, the access node may signal the CID and the congestion level in combination. For example, the access node may send the CID and the congestion level in the same packet sent on the subject bearer. After receiving a packet indicating the congestion level from the access node, the PGW may send an acknowledgment in return. The access node may repeat sending the congestion indication if it does not receive an acknowledgment, for example, use methods similar to those described with reference to step 540 in the process of FIG. 5.

Another method the access node may use to signal congestion in the access network to the CN is control plane congestion signaling. The access node can include the CID in a control message signaled from the access node to the PGW, via the MME or the SGW.

FIG. 8 is a flowchart of a process for a network node in a core network to manage congestion in an access network coupled to the core network in accordance with aspects of the invention. The network node may be, for example, the PGW 131 of the communication network of FIG. 1, or may be another node that performs congestion mitigation functionality. The process of FIG. 8 can use information from the process of FIG. 6, however, the processes may also be performed concurrently.

In step 810 in the process of FIG. 8, the PGW receives notifications of congestion levels, for example, as sent by the access node in step 720 in the process of FIG. 7. The method used by the PGW to receive the congestion level is based on the method of signaling used by the access node.

In step 820, the PGW associates bearers with the congestion notification received in step 810. The process may somewhat vary with the method of signaling used by the access node. With in-band congestion signaling, the PGW can determine the associated CID from the bearer in which the congestion notification is received. With control plane congestion signaling, the CID is identified in the congestion notification. The PGW can map the CID to the bearers that are affected by or contribute to the congestion. The PGW can, for example, use associations from step 630 in the process of FIG. 6 to associates bearers with the congestion notification.

In step 830, the PGW mitigates the access network congestion. Example mitigation methods include delaying or dropping data, reducing the bit rate on certain bearers, or marking packets for use in mitigation by the access node.

The process of FIGS. 5, 6, 7, and 8 may be modified by adding, omitting, reordering, or altering steps. Additionally, steps may be performed concurrently and a step that occurs after another step need not be immediately after.

The systems and methods described herein enable the CN to identify bearers impacted by congestion in the access network without heavily increasing the signaling load. Additionally, these systems and methods allow the CN to identify the impacted bearers when the access network signals a change in congestion level to the CN.

The foregoing systems and methods and associated devices, nodes, and modules are susceptible to many variations. For example, functions described as being performed by one module or node may be performed by another module or node. For example, although the access node is identified above as the node that selects and sends the CID to the PGW, in a variation, the MME or the SGW may be the entity in the core network that selects the CID, sends the CID, or selects and sends the CID to the PGW. Additionally, the functionality and architecture of each of the various modules and nodes described above may be distributed, grouped, co-located, and combined in various embodiments.

Additionally, for clarity and brevity, many descriptions of the systems and methods have been simplified. Similarly, many descriptions use terminology and structures of a specific wireless standard such as LTE. However, the disclosed systems and methods are more broadly applicable, including for example, in hybrid fiber-coax cable modem systems.

Those of skill will appreciate that the various illustrative logical blocks, modules, units, and algorithm steps described in connection with the embodiments disclosed herein can often be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular constraints imposed on the overall system. Skilled persons can implement the described functionality in varying ways for each particular system, but such implementation decisions should not be interpreted as causing a departure from the scope of the invention. In addition, the grouping of functions within a unit, module, block, or step is for ease of description. Specific functions or steps can be moved from one unit, module, or block without departing from the invention.

The various illustrative logical blocks, units, steps and modules described in connection with the embodiments disclosed herein can be implemented or performed with a processor, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

The steps of a method or algorithm and the processes of a block or module described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium. An exemplary storage medium can be coupled to the processor such that the processor can read information from, and write information to, the storage medium. In the alternative, the storage medium can be integral to the processor. The processor and the storage medium can reside in an ASIC. Additionally, device, blocks, or modules that are described as coupled may be coupled via intermediary device, blocks, or modules. Similarly, a first device may be described a transmitting data to (or receiving from) a second device when there are intermediary devices that couple the first and second device and also when the first device is unaware of the ultimate destination of the data.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter that is broadly contemplated by the present invention. It is further understood that the scope of the present invention fully encompasses other embodiments that may become obvious to those skilled in the art and that the scope of the present invention is accordingly limited by nothing other than the appended claims.

What is claimed is:

1. A method for an access node to report access network congestion to a network node in a core network, the method comprising:
detecting a bearer transition event for a first bearer associated with a user equipment that is in communication with the access node;
determining a congestion identifier that is associated with a set of bearers for association with the first bearer; and
sending the congestion identifier and information identifying the first bearer to the network node.

2. The method of claim 1, wherein the set of bearers associated with the congestion identifier are further associated with an access network cell, multiple access network cells, or an access network cell sector.

3. The method of claim 1, wherein the set of bearers associated with the congestion identifier are further associated with a class of service.

4. The method of claim 1, wherein the value of the congestion identifier is a cell identifier, a cell global identifier, an access node internet protocol (IP) address, an access node media access control (MAC) address, a physical cell identifier, or a random number.

5. The method of claim 1, wherein the bearer transition event is a bearer setup or a bearer handover.

6. The method of claim 1, wherein the bearer transition event is an attachment of the user equipment to the access network via the access node.

7. The method of claim 1, wherein the bearer transition event is a handover of the user equipment to the access node from another access node.

8. The method of claim 1, wherein the bearer transition event is a state transition of the user equipment from an idle state to a connected state.

9. The method of claim 1, wherein the bearer transition event is an establishment of a new bearer associated with the user equipment.

10. The method of claim 1, wherein the congestion identifier is dynamic.

11. The method of claim 1, wherein the network node is a packet data network gateway, and the bearer is via a serving gateway.

12. The method of claim 1, further comprising sending a null congestion identifier from the access node to the network node, wherein the null congestion identifier signals the network node to disassociate the bearer from a congestion identifier.

13. The method of claim 12, wherein the null congestion identifier is sent to the network node after handover of the user equipment from the access node to another access node.

14. The method of claim 12, wherein the null congestion identifier is sent to the network node after the user equipment enters an idle state.

15. The method of claim 1, wherein the congestion identifier value is sent to the network node using the bearer.

16. The method of claim 1, wherein the congestion identifier value is sent to the network node after determining that a probability of access network congestion within a time window exceeds a threshold.

17. The method of claim 16, wherein the probability is based on at least one of an access network resource utilization, an access network scheduling queue level, or an access network scheduling queue packet aging level.

18. The method of claim 16, wherein the probability is based on a predetermined congestion pattern.

19. The method of claim 1, wherein the congestion identifier value is sent to the network node after detecting access network congestion.

20. The method of claim 1, wherein a time of sending the congestion identifier to the network node is based on characteristics of the bearer.

21. The method of claim 1, wherein a time of sending the congestion identifier to the network node is based on characteristics associated with the user equipment.

22. The method of claim 1, further comprising
detecting a congestion level in an access network served by the access node; and
sending a congestion level indication to the network node, wherein the congestion level indication is based on the detected congestion level.

23. The method of claim 22, wherein the congestion level indication is sent on the bearer to the network node.

24. The method of claim 22, wherein the bearer is one of a plurality of bearers between the access node and the network node, and wherein the congestion level indication is sent to the network node in a subset of the plurality of bearers.

25. The method of claim 22, wherein the congestion level indication is sent in a control message to the network node.

26. The method of claim 22, wherein the congestion level indication and the congestion identifier value are sent to the network node in a same packet.

27. An access node serving a cell in an access network coupled to a core network, the access node comprising:
a transceiver module configured to receive and send data via the access network;
a backhaul interface module configured to receive and send data via the core network;
a memory module; and
a processor module coupled to the transceiver module, the backhaul interface module, and the memory module and configured to:
detect a bearer transition event for a first bearer associated with a user equipment that is in communication with the access node;
determine a congestion identifier that is associated with a set of bearers for association with the first bearer; and
send the congestion identifier and information identifying the first bearer from the access node to a network node.

28. The access node of claim 27, wherein the set of bearers associated with the congestion identifier are further associated with an access network cell, multiple access network cells, or an access network cell sector.

29. The access node of claim 27, wherein the set of bearers associated with the congestion identifier are further associated with a class of service.

30. The access node of claim 27, wherein the value of the congestion identifier is a cell identifier, a cell global identifier, an access node internet protocol (IP) address, an access node media access control (MAC) address, a physical cell identifier, or a random number.

31. The access node of claim 27, wherein the bearer transition event is a bearer setup or a bearer handover.

32. The access node of claim 27, wherein the bearer transition event is an attachment of the user equipment to the access network via the access node.

33. The access node of claim 27, wherein the bearer transition event is a handover of the user equipment to the access node from another access node.

34. The access node of claim 27, wherein the bearer transition event is a state transition of the user equipment from an idle state to a connected state.

35. The access node of claim 27, wherein the bearer transition event is an establishment of a new bearer associated with the user equipment.

36. The access node of claim 27, wherein the congestion identifier is dynamic.

37. The access node of claim 27, wherein the network node is a packet data network gateway, and the bearer is via a serving gateway.

38. The access node of claim 27, wherein the processor module is further configured to send a null congestion identifier from the access node to the network node, wherein the null congestion identifier signals the network node to disassociate the bearer from a previous congestion identifier.

39. The access node of claim 38, wherein the processor module is further configured to send the null congestion identifier from the access node to the network node after handover of the user equipment from the access node to another access node.

40. The access node of claim 38, wherein the processor module is further configured to send the null congestion identifier from the access node to the network node after the user equipment enters an idle state.

41. The access node of claim 27, wherein the congestion identifier value is sent to the network node using the bearer.

42. The access node of claim 27, wherein the congestion identifier value is sent to the network node after determining that a probability of access network congestion within a time window exceeds a threshold.

43. The access node of claim 42, wherein the probability is based on at least one of an access network resource utilization, an access network scheduling queue level, or an access network scheduling queue packet aging level.

44. The access node of claim 42, wherein the probability is based on a predetermined congestion pattern.

45. The access node of claim 27, wherein the congestion identifier value is sent to the network node after detecting access network congestion.

46. The access node of claim 27, wherein a time of sending the congestion identifier value to the network node is based on characteristics of the bearer.

47. The access node of claim 27, wherein a time of sending the congestion identifier value to the network node is based on characteristics associated with the user equipment.

48. The access node of claim 27, wherein the processor module is further configured to:
detect a congestion level in an access network served by the access node; and
send a congestion level indication to the network node, wherein the congestion level indication is based on the detected congestion level.

49. The access node of claim 48, wherein the congestion level indication is sent on the bearer to the network node.

50. The access node of claim 48, wherein the bearer is one of a plurality of bearers between the access node and the network node, and wherein the congestion level indication is sent to the network node in a subset of the plurality of bearers.

51. The access node of claim 48, wherein the congestion level indication is sent in a control message to the network node.

52. The access node of claim 48, wherein the congestion level indication and the congestion identifier value are sent to the network node in a same packet.

53. A method for a network node in a core network to manage congestion in an access network coupled to the core network, the method comprising:
receiving a congestion identifier and information identifying a first bearer;
associating the congestion identifier with the first bearer based on the information identifying the first bearer;
receiving a congestion level indication; and
associating the congestion level indication with the congestion identifier.

54. The method of claim 53, wherein the method further includes mitigating congestion on the first bearer.

55. The method of claim 53, wherein the congestion identifier is a cell identifier, a cell global identifier, an access node internet protocol (IP) address, an access node media access control (MAC) address, a physical cell identifier, or a random number.

56. The method of claim 53, further comprising sending an identifier of the network node in response to receiving the congestion identifier.

57. The method of claim 53, further comprising:
receiving a null congestion identifier for the first bearer; and
disassociating the first bearer from a previous congestion identifier.

58. The method of claim 53, wherein the congestion identifier is received on one of a plurality of bearers, and wherein associating the congestion identifier with the first bearer is based on the one of the plurality of bearers on which the congestion identifier value is received.

59. The method of claim 53, wherein the congestion level indication is received on one of a plurality of bearers, and wherein associating the congestion level indication with the congestion identifier comprises:
determining the congestion identifier associated with the one of the plurality of bearers on which the congestion identifier is received; and
determining the one or more of the plurality of bearers connected to the network node that are associated with the congestion identifier value associated with the one of the plurality of bearers on which the congestion identifier is received.

60. A network node in a core network coupled to an access network, the network node comprising:
an input/output module configured to communicate with an access node in the access network;
a memory module; and
a processor module coupled to the input/output module and the memory module and configured to:
receive, from the access node, a congestion identifier and information identifying a first bearer;
associate the congestion identifier with the first bearer based on the information identifying the first bearer;
receive, from the access node, a congestion level indication; and
associate the congestion level indication with the congestion identifier.

61. The network node of claim 60, wherein the processor module is further configured to mitigate congestion on the first bearer.

62. The network node of claim 60, wherein the congestion identifier is a cell identifier, a cell global identifier, an access node internet protocol (IP) address, an access node media access control (MAC) address, a physical cell identifier, or a random number.

63. The network node of claim 60, wherein comprising send an identifier of the network node to the access node in response to receiving the congestion identifier.

64. The network node of claim 60, wherein the processor module is further configured to:
receive a null congestion identifier for the first bearer; and
disassociate the first bearer from a previous congestion identifier.

65. The network node of claim 60, wherein the congestion identifier is received on one of a plurality of bearers, and wherein the processor module is further configured to associate the congestion identifier with the first bearer based on the one of the plurality of bearers on which the congestion identifier is received.

66. The network node of claim 60, wherein the congestion level indication is received on one of a plurality of bearers, and wherein the processor module is further configured to associate the congestion level indication with the first bearer by:
determining the congestion identifier associated with the one of the plurality of bearers on which the congestion identifier is received; and
determining the one or more of the plurality of bearers connected to the network node that are associated with the congestion identifier value associated with the one of the plurality of bearers on which the congestion identifier is received.
